(19) United States
(12) Patent Application Publication
(10) Pub. No.: US 2025/0108635 A1
(43) Pub. Date: Apr. 3, 2025

(54) LIQUID DISCHARGE APPARATUS

(71) Applicant: Yuichiro MAEYAMA, Kanagawa (JP)

(72) Inventor: Yuichiro MAEYAMA, Kanagawa (JP)

(21) Appl. No.: 18/901,048

(22) Filed: Sep. 30, 2024

(30) Foreign Application Priority Data
Oct. 2, 2023 (JP) 2023-171264
Jun. 6, 2024 (JP) 2024-092191

(51) Int. Cl. B41J 11/00; B41J 13/03; G01D 5/347

(52) U.S. Cl. CPC B41J 11/0095; B41J 13/03; G01D 5/3473

(57) ABSTRACT

A liquid discharge apparatus includes a rotator rotatable around a shaft to carry a recording medium on an outer circumferential surface of the rotator to convey the recording medium in a conveyance direction; multiple discharge units to discharge liquid onto the recording medium; a sheet detector to detect the recording medium; an encoder wheel on the shaft of the rotator; a first encoder sensor to read the encoder wheel; an encoder scale on the outer circumferential surface of the rotator; a second encoder sensor to read the encoder scale; and circuitry configured to determine a discharge start timing of at least one of the multiple discharge units based on detection results of the sheet detector, the first encoder sensor, and the second encoder sensor.

### CROSS-REFERENCE TO RELATED APPLICATIONS

This patent application is based on and claims priority pursuant to 35 U.S.C. § 119 (a) to Japanese Patent Application No. 2023-171264, filed on Oct. 2, 2023, in the Japan Patent Office, and Japanese Patent Application No. 2024-092191, filed on Jun. 6, 2024, in the Japan Patent Office, the entire disclosure of which is hereby incorporated by reference herein.

### BACKGROUND

### Technical Field

The present embodiment relates to a liquid discharge apparatus.

### Related Art

In a liquid discharge apparatus, a recording medium is carried and conveyed on a surface of a conveyance drum as a rotator, and liquid is discharged by a liquid discharge head of each color facing the conveyance drum to form an image.

In such a liquid discharge apparatus, a position of the recording medium to be conveyed is detected by an encoder sensor or the like, and liquid of each color is discharged onto the recording medium by each liquid discharge head at a timing when the recording medium passes.

For example, after a sheet material position sensor detects a leading end of a sheet material, the liquid discharge apparatus reads an encoder wheel provided on a shaft of the conveyance drum by the encoder sensor, and determines timing of starting liquid discharge by each liquid discharge head. Then, the discharge timing after the start of discharge by the liquid discharge head is determined by reading an encoder scale attached to a circumferential surface of the conveyance drum by another encoder sensor provided in a liquid discharge unit.

### SUMMARY

In an aspect of the present disclosure, a liquid discharge apparatus is provided that includes a rotator rotatable around a shaft to carry a recording medium on an outer circumferential surface of the rotator to convey the recording medium in a conveyance direction; multiple discharge units to discharge liquid onto the recording medium; a sheet detector to detect the recording medium; an encoder wheel on the shaft of the rotator; a first encoder sensor to read the encoder wheel; an encoder scale on the outer circumferential surface of the rotator; a second encoder sensor to read the encoder scale; and circuitry configured to determine a discharge start timing of at least one of the multiple discharge units based on detection results of the sheet detector, the first encoder sensor, and the second encoder sensor.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic configuration diagram of a printing apparatus;

FIG. 2 is a plan view of a discharge unit;

FIG. 3 is a front view illustrating a printing device of a printing apparatus according to a first embodiment of the present embodiment;

FIG. 4 is a plan view of the printing device of FIG. 3;

FIG. 5 is a conceptual diagram illustrating a discharge start timing and a discharge timing of the printing device of the first embodiment;

FIG. 6 is a flowchart of a discharge operation of the printing device of the first embodiment;

FIG. 7 is a block diagram illustrating a control configuration related to discharge of a printing apparatus of the first embodiment;

FIG. 8 is a conceptual diagram illustrating a discharge start timing and a discharge timing of a printing device of a second embodiment;

FIG. 9 is a flowchart of a discharge operation of the printing device of the second embodiment;

FIG. 10 is a conceptual diagram illustrating a discharge start timing and a discharge timing of a printing device of a third embodiment;

FIG. 11 is a flowchart of a discharge operation of the printing device of the third embodiment;

FIG. 12 is a block diagram illustrating a control configuration related to discharge of a printing apparatus of the third embodiment;

FIG. 13 is a conceptual diagram illustrating a discharge start timing and a discharge timing of a printing device of a fourth embodiment;

FIG. 14 is a flowchart of a discharge operation of the printing device of the fourth embodiment; and

FIG. 15 is a block diagram illustrating a control configuration related to the discharge of a printing apparatus of the fourth embodiment.

FIG. 16 is a block diagram illustrating a hardware configuration of the printing apparatus of the first embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, an embodiment according to the present embodiment will be described with reference to the drawings. Note that identical parts are given identical reference numerals and redundant descriptions are summarized or omitted accordingly.

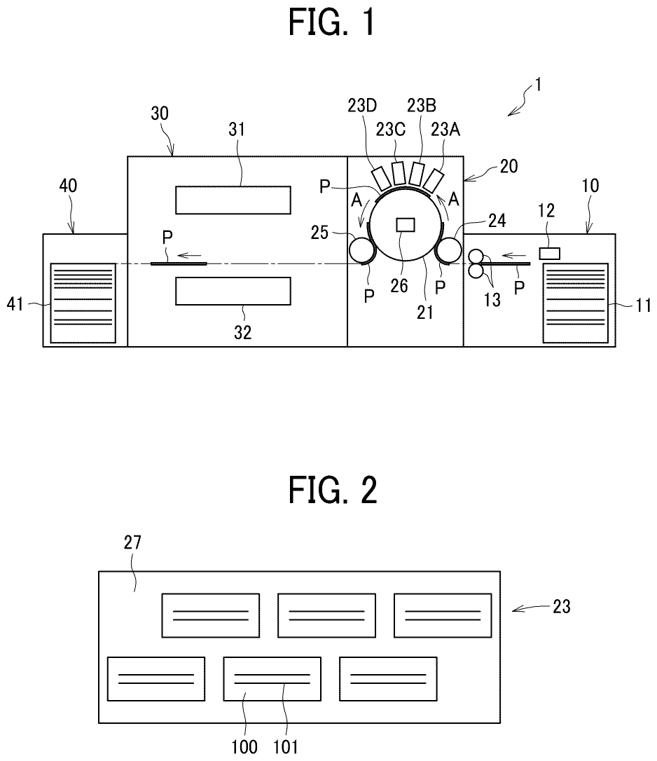

Hereinafter, an embodiment according to the present embodiment will be described with reference to the accompanying drawings. First, a liquid discharge apparatus according to a first embodiment of the present embodiment will be described with reference to FIG. 1. FIG. 1 is a schematic explanatory diagram of a printer as a liquid discharge apparatus according to the embodiment. This printer discharges ink as liquid to form an image on a sheet as a recording medium.

The printer 1 includes a loading device 10, a printing device 20, a drying device 30, and an unloading device 40. The printer 1 applies liquid to a sheet P as a recording medium carried in from the loading device 10 by the printing device 20 to perform required printing, dries the liquid attached to the sheet P by the drying device 30, and then discharges the sheet P to the unloading device 40.

The loading device 10 includes a loading tray 11 on which a plurality of the sheets P is stacked, a feeding unit 12 that separates and feeds the sheets P one by one from the loading tray 11, and a registration roller pair 13 that feeds the sheet P to the printing device 20.

Any feeding unit such as a device using a roller or a rolling element using air suction may be used as the feeding unit 12. After a leading end of the sheet P fed from the loading tray 11 by the feeding unit 12 reaches the registration roller pair 13, the registration roller pair 13 is driven at a predetermined timing to feed the sheet P to the printing device 20.

The printing device 20 includes a conveyance drum 21 that is a conveyance unit that carries and conveys the sheet P on the outer circumferential surface, and a plurality of discharge units 23A to 23D that discharges liquid toward the sheet P carried on the conveyance drum 21.

Furthermore, the printing device 20 includes a transfer cylinder 24 that receives the fed sheet P and transfers the sheet P to the conveyance drum 21, and a transfer cylinder 25 that transfers the sheet P conveyed by the conveyance drum 21 to the drying device 30.

The sheet P conveyed from the loading device 10 to the printing device 20 is gripped by a sheet gripper provided on the surface of the transfer cylinder 24, and the sheet P is conveyed in a direction of an arrow A with the rotation of the transfer cylinder 24. The sheet P conveyed by the transfer cylinder 24 is delivered to the conveyance drum 21 at a position opposite to the conveyance drum 21.

A sheet gripper is also provided on the surface of the conveyance drum 21, and the leading end of the sheet P is gripped by the sheet gripper. A plurality of suction holes is dispersedly formed on the surface of the conveyance drum 21. A suction airflow directed inward from the suction holes of the conveyance drum 21 is generated by an attraction device 26 that is an attraction unit.

Then, the leading end of the sheet P delivered from the transfer cylinder 24 to the conveyance drum 21 is gripped by the sheet gripper, and the sheet P is attracted onto the conveyance drum 21 by the suction airflow by the attraction device 26, and is conveyed with the rotation of the conveyance drum 21.

The printing device 20 includes a plurality of discharge units as multiple discharge units. In the present embodiment, four discharge units 23A to 23D are provided. The discharge unit 23A is a first discharge unit of the present embodiment. Hereinafter, the discharge units 23A to 23D are also referred to as discharge units 23. For example, the discharge unit 23A discharges a black (K) liquid, the discharge unit 23B discharges a cyan (C) liquid, the discharge unit 23C discharges a magenta (M) liquid, and the discharge unit 23D discharges a yellow (Y) liquid. In addition, it is also possible to provide a discharge unit that discharges a special liquid such as white or gold (silver) or a treatment liquid such as a surface coating liquid, and the number of the discharge units 23 is not limited to this embodiment. Furthermore, the order of the ink to be discharged is not limited to the present embodiment, and can be appropriately changed.

A discharge operation of each of the discharge units 23 is controlled by a drive signal according to print information. When the sheet P carried on the conveyance drum 21 passes through a region facing the discharge unit 23, liquid of each color is discharged from each of the discharge units 23, and an image according to print information is printed.

The drying device 30 includes a drying mechanism 31 and a suction conveyance mechanism 32. The drying mechanism 31 dries the liquid adhered on the sheet P by the printing device 20. The suction conveyance mechanism 32 conveys (suctions and conveys) the sheet P conveyed from the printing device 20 in a suctioned state.

After the sheet P conveyed from the printing device 20 is received by the suction conveyance mechanism 32, the sheet P is conveyed to pass through the drying mechanism 31, and delivered to the unloading device 40.

When the sheet P passes through the drying mechanism 31, the liquid on the sheet P is subjected to drying processing. As a result, the liquid content such as moisture in the liquid evaporates, the colorant contained in the liquid is fixed on the sheet P, and curling of the sheet P is suppressed.

The unloading device 40 includes an unloading tray 41 on which the plurality of sheets P is stacked. The sheets P conveyed from the drying device 30 are sequentially stacked and held on the unloading tray 41.

Note that, the printer 1 can further include, for example, a pretreatment device disposed on an upstream side of the printing device 20, or a post-processing device disposed between the drying device 30 and the unloading device 40.

40. The pretreatment device performs pretreatment on the sheet P. The post-processing device performs post-processing of the sheet P onto which the liquid has been applied.

Examples of the pretreatment device include, for example, a device that performs pre-coating treatment of applying a treatment liquid for suppressing bleeding by reacting with the liquid to the sheet P. Furthermore, examples of the post-processing device include, for example, a device that performs sheet reverse conveyance processing for reversing the sheet printed by the printing device 20 and sending the sheet to the printing device 20 again to perform printing on both sides of the sheet P, processing of binding a plurality of the sheets, and the like.

For example, as illustrated in FIG. 2, the discharge unit 23 is a full-line head in which a plurality of liquid discharge heads (hereinafter, simply referred to as a “head”) 100 including a nozzle row 101 in which a plurality of nozzles is arranged is arranged on a base member 27.

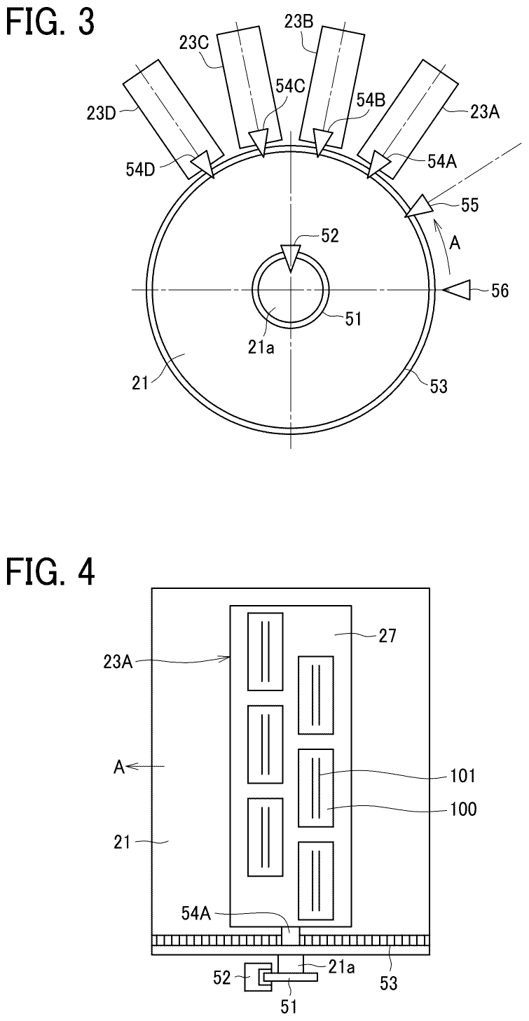

Next, a configuration for controlling a liquid discharge timing by the liquid discharge head in the printing device 20 will be described with reference to FIGS. 3 and 4.

As illustrated in FIGS. 3 and 4, an encoder wheel 51 is provided on a shaft 21a of the conveyance drum 21. A first encoder sensor 52 that reads the encoder wheel 51 is provided opposite the encoder wheel 51. The encoder wheel 51 and the first encoder sensor 52 constitute a shaft encoder that is a rotary encoder. The shaft encoder, that is, the first encoder sensor 52 outputs a first signal according to a rotation amount of the shaft 21a.

As illustrated in FIG. 3, an encoder scale 53 is provided on the outer circumferential surface of the conveyance drum 21. The encoder scale 53 is provided by pasting a longitudinal scale along the entire circumference of the circumferential surface of the conveyance drum 21, and a break, which is a gap between both ends of the scale before pasting, is provided at one position in a circumferential direction of the conveyance drum 21. The conveyance drum 21 rotates in a direction of an arrow A in FIG. 3, and this direction is a conveyance direction of the sheet P. Hereinafter, an upstream side and a downstream side in the conveyance direction of the sheet P are also simply referred to as upstream side or downstream side.

Furthermore, a second encoder sensor for reading the encoder scale 53 includes multiple head-side sensors 54A to 54D provided corresponding to the discharge units 23A to 23D, and a drum surface sensor 55 provided at a position not corresponding to the discharge units 23 separately from the multiple head-side sensors 54A to 54D corresponding to the discharge units 23A to 23D. In the present embodiment, each of the multiple head-side sensors 54A to 54D is attached to the base member 27 (see FIG. 4) of each of the discharge units 23A to 23D. Hereinafter, the multiple head-side sensors 54A to 54D are also referred to as head-side sensors 54. Furthermore, the arrangement of the drum surface sensor 55 is determined such that the break of the encoder scale 53 does not come to a position facing the drum surface sensor 55 within a section where pulses by the drum surface sensor 55 are counted in order to determine a discharge start timing (the discharge start timing will be described later). In the present embodiment, the drum surface sensor 55 is provided on the upstream side of the most upstream discharge unit 23A in a sheet conveyance direction. The encoder scale 53 and the head-side sensors 54A to 54D constitute a head-side encoder. The encoder scale 53 and the drum surface sensor 55 constitute a drum surface encoder. The head-side encoder and the drum surface encoder, that is, the head-side sensors 54A to 54D and the drum surface sensor 55 output a second signal according to a movement amount of the outer circumferential surface of the conveyance drum 21. That is, the second signal is a signal correlated with the movement amount of the sheet P conveyed on the surface of the conveyance drum 21. However, the encoder scale 53 may be provided in a portion having a diameter smaller than that of the portion that attracts and conveys the sheet P on the outer circumferential surface of the conveyance drum 21, and the diameter does not need to completely match that of the portion that attracts and conveys the sheet P of the conveyance drum 21. The encoder scale 53 is an encoder having a diameter larger than that of the encoder wheel 51 and having a break at any position in the circumferential direction. Furthermore, in the present embodiment, each of the head-side sensors 54A to 54D is provided in the base member 27 provided with the liquid discharge head, but the head-side sensors 54A to 54D may be provided in a member different from the member provided with the liquid discharge head.

The second encoder sensor corresponding to each of the discharge units 23A to 23D described above refers to each sensor provided at a position closest to (or the same as) each of the discharge units 23A to 23D in the circumferential direction among the sensors that read the encoder scale 53, and the second encoder sensor not corresponding to the discharge units 23 refers to a sensor that reads the encoder scale 53 provided in addition to the sensors corresponding to each of the discharge units 23A to 23D.

A sheet detection sensor 56 as a recording medium detector is provided on the upstream side of the most upstream discharge unit 23A in the sheet conveyance direction. When the leading end of the sheet P reaches the sheet detection sensor 56, the sheet detection sensor 56 detects this, and a control section of the liquid discharge apparatus can recognize that the sheet P reaches the sheet detection sensor 56. However, the sheet detection sensor 56 may read a mark attached to the sheet P. As a result, it is possible to detect a predetermined position other than the leading end of the recording medium, and it is also possible to detect a continuous recording medium such as a continuous sheet of paper. The recording medium detector is also referred to simply as “a sheet detector”.

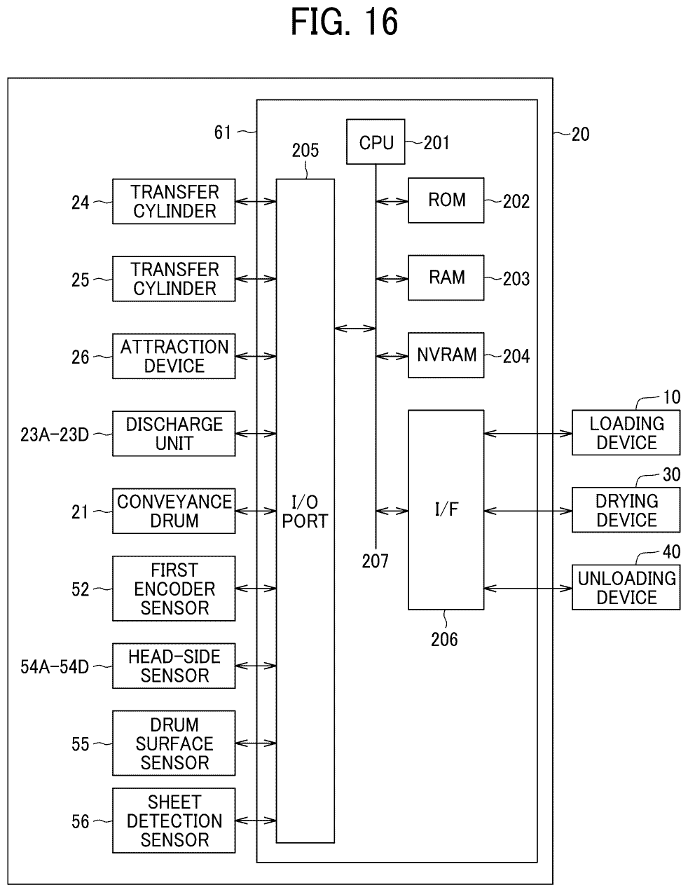

A hardware configuration of the printing apparatus 1 is described below. FIG. 16 is a block diagram illustrating a hardware configuration of the printing apparatus 1 according to a first embodiment of the present disclosure.

The main substrate 61 includes a CPU (Center Processing Unit) 201, a ROM (Read Only Memory) 202, a RAM (Random Access Memory) 203, an NVRAM (Non-Volatile Random Access Memory) 204, an input/output device (I/O port) 205, an I/F (Interface) 206, which are connected to each other via a bus 207.

The CPU 201 is a calculation unit and controls the operation of the entire printing apparatus 1. The ROM 202 is a read-only nonvolatile memory and stores programs such as firmware. The RAM 203 is a volatile memory capable of reading and writing information at high speed and is used as a work area when the CPU 201 processes information. The NVRAM 204 is a non-volatile memory capable of reading and writing information, and stores setting values used for controlling each unit of the printing apparatus 1. The program stored in the ROM 202 is read out to the RAM 203. The CPU 201 performs calculations according to the program loaded in the RAM 203 to control each unit of the printing apparatus 1. At this time, the CPU 201 uses a set value stored in the NVRAM 204.

The I/O port 205 is connected to the drive units of the respective units of the printing device 20 such as the transfer cylinder 24, the transfer cylinder 25, the attraction device 26, the discharge units 23A to 23D, the conveyance drum 21 and the sensor group such as the first encoder sensor 52, the head-side sensors 54A to 54D, the drum surface sensor 55, and the sheet detection sensor 56. The CPU 201 controls each unit based on the state of the input sensor signal. The CPU 201 also executes control of the discharge timing of the discharge units 23A to 23D as described below based on the program stored in the ROM 202.

The CPU 201 is also connected to the loading device 10, the drying device 30, and the unloading device 40 of the printing apparatus 1 via the I/F206. The CPU 201 directly controls each unit or communicates with another control unit in each unit to control the entire printing apparatus 1.

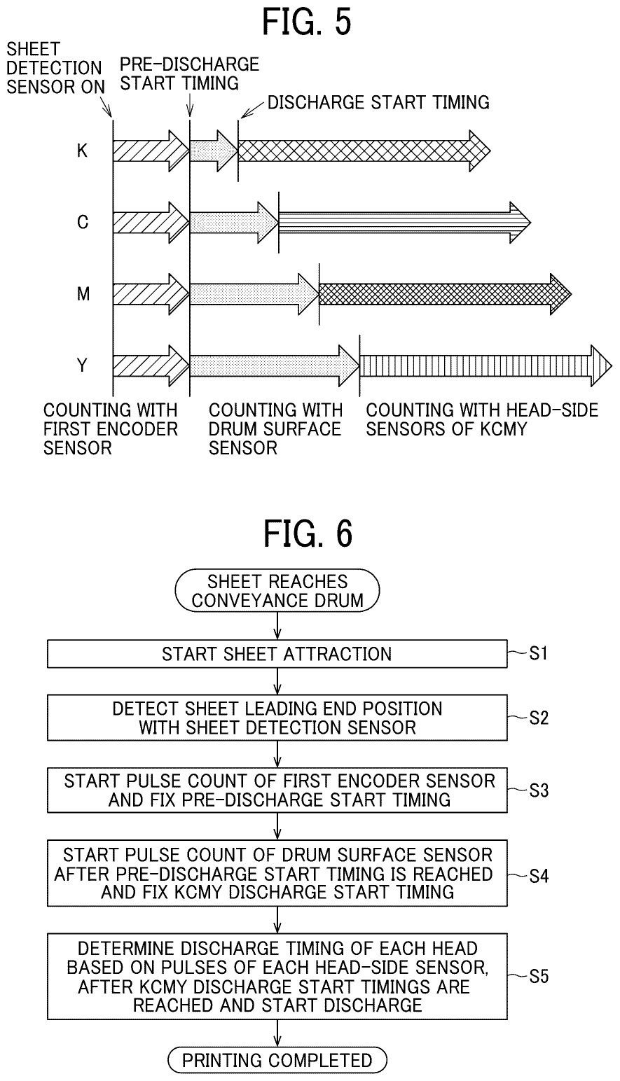

Next, the discharge start timing and the discharge timing by the liquid discharge head of each discharge unit will be described using the conceptual diagrams of FIG. 3 described above and FIG. 5, and the flowchart of FIG. 6. Note that, in FIG. 5, the discharge units 23 are indicated by K, C, M, and Y, which are the colors of the liquid discharged from the discharge unit 23. That is, “K” in FIG. 5 indicates the discharge unit 23A, “C” indicates the discharge unit 23B, “M” indicates the discharge unit 23C, and “Y” indicates the discharge unit 23D. The discharge start timing or the discharge timing by the liquid discharge head of the discharge unit is also simply referred to as the discharge start timing or the discharge timing of the discharge unit.

When the sheet P reaches the surface of the conveyance drum 21, the attraction device 26 attracts the sheet P onto the surface of the conveyance drum 21 (step S1 in FIG. 6). Then, the conveyance drum 21 rotates, and the leading end of the sheet P is detected by the sheet detection sensor 56 (step S2). With this timing as a trigger, as illustrated in FIG. 5, the control section counts pulses output from the first encoder sensor 52 by reading the encoder wheel 51. Then, a pre-discharge start timing, which is a predetermined timing before the start of discharge by the liquid discharge head, is fixed based on the pulses from the first encoder sensor 52 (step S3).

Thereafter, when the pre-discharge start timing is reached, the control section starts counting pulses output by the drum surface sensor 55 reading the encoder scale 53 instead of the pulses by the first encoder sensor 52. Then, the discharge start timing by the liquid discharge head of each discharge unit 23 is determined based on the pulses by the drum surface sensor 55 (step S4). As described above, the discharge start timing by the liquid discharge head of each discharge unit 23 is determined. In other words, the sheet detection sensor 56, the first encoder sensor 52, and the drum surface sensor 55 determine the discharge start timing by the liquid discharge head of each discharge unit 23. Note that the discharge units 23B to 23D of the CMY on the downstream side can similarly set the timing even if the discharge start timing is determined by the pulse count of the drum surface sensor 55 from the discharge start timing of the discharge unit 23A of the most upstream K.

After reaching the discharge start timing, the discharge timing after the start of discharge by the liquid discharge head of each discharge unit 23 is determined based on the pulses of the corresponding head-side sensor instead of the drum surface sensor 55, and the discharge operation by each liquid discharge head is started (step S5). Then, when the discharge operation by all the discharge units 23 is completed, the printing operation on the sheet P is ended. Note that the discharge start timing of the discharge unit 23 is the timing at which liquid is first discharged to the recording medium in each discharge unit 23, and the discharge timing after the start of discharge is each timing at which liquid is discharged to the recording medium for the second and subsequent times in the discharge unit 23.

As described above, according to the present embodiment, the discharge start timing by the liquid discharge head of each of the discharge units 23A to 23D can be determined based on the pulses of the drum surface sensor 55 that reads the encoder scale 53 provided on the surface of the conveyance drum 21. As a result, the liquid discharge apparatus can detect a surface movement amount of the conveyance drum 21, that is, a movement amount of the sheet P without being affected by the rotation accuracy of the conveyance drum 21 or the dimensional accuracy of the conveyance drum 21, and the position of the sheet P can be accurately detected. Therefore, each liquid discharge head can reduce the shift of an image forming position with respect to the sheet P. As a result, it is possible to suppress the shift of the discharge start position between the discharge units, and it is possible to improve the quality of the image formed on the sheet P. Furthermore, the above effect can be obtained by the configuration in which the encoder scale 53 is attached to the surface of the conveyance drum 21, the cost of the liquid discharge apparatus can be reduced, and the large conveyance drum 21 can be easily coped with. The first encoder that is an encoder on a shaft side of the conveyance drum 21, and the drum surface encoder and the head-side encoder that are encoders on a surface side of the conveyance drum 21 are used together to determine the discharge start timing, whereby the position of the sheet P can be detected without any break even in a configuration in which there is a break in the encoder scale 53 on the circumference of the conveyance drum 21.

The head-side sensors 54A to 54D also read the encoder scale 53 to determine the discharge timing of each discharge unit 23 after the start of discharge. Therefore, an error of the timing, that is, an error of the discharge position to the sheet P can be reduced.

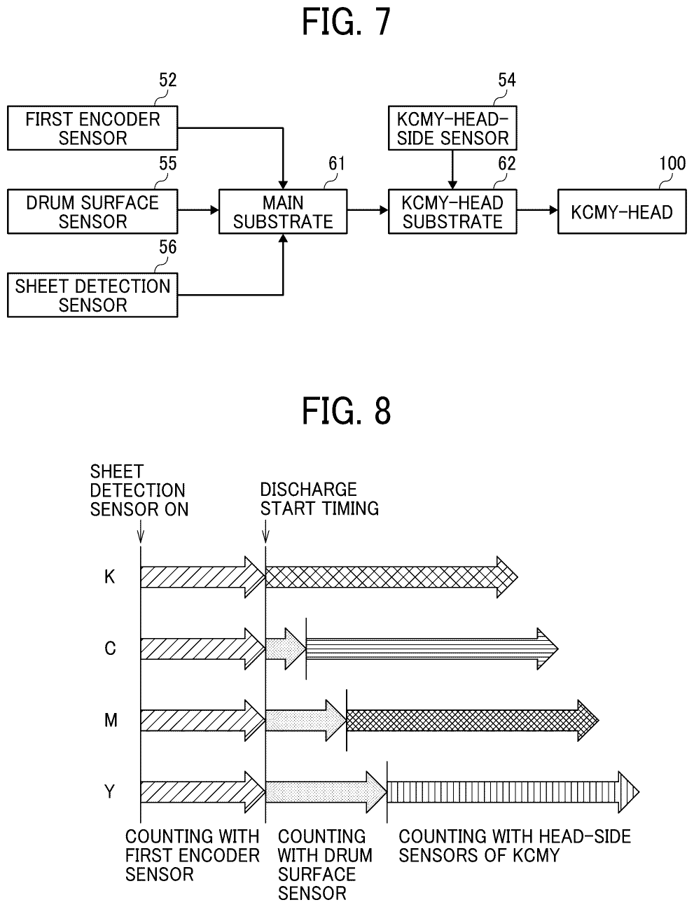

FIG. 7 is a block diagram illustrating a part related to the control of the discharge timing of the control section of the liquid discharge apparatus.

As illustrated in FIG. 7, the liquid discharge apparatus includes a main substrate 61 and a head substrate 62.

The head substrate 62 is provided in each liquid discharge head 100 of each discharge unit 23, and in FIG. 7, a “KCMY-head substrate” means that there is the head substrate 62 provided in each discharge unit 23 of KCMY. The same applies to a “KCMY-head-side sensor” or a “KCMY-head”.

Signals of the first encoder sensor 52, the drum surface sensor 55, and the sheet detection sensor 56 are input to the main substrate 61. Based on these pieces of information, as described above, the main substrate 61 determines the discharge start timing of each liquid discharge head 100 and inputs the discharge start timing to the head substrate 62. As described above, the main substrate 61 is a discharge start timing determination mechanism that determines the discharge start timing of each liquid discharge head. Each head substrate 62 determines and inputs a discharge timing (Hereinafter, it is also simply referred to as a discharge timing.) after the start of discharge by each liquid discharge head based on a discharge start timing input from the main substrate 61 and a signal input from the head-side sensor 54.

As described above, the head substrate 62 is a discharge timing determination mechanism. To be precise, the head substrate 62 is provided for each of a plurality of the liquid discharge heads 100 provided in each discharge unit 23, and information is input from the main substrate 61 to each head substrate 62. Furthermore, information is input from each of the head-side sensors 54 of KCMY to the corresponding head substrate 62 and the corresponding liquid discharge head 100.

In the above description, the discharge start timings of all the discharge units 23 are determined using the pulses of the second encoder sensor, but not necessarily all the discharge start timings are determined.

Next, modifications in which the control configuration or the control method of the discharge start timing and the discharge timing after the start of discharge of the liquid discharge apparatus of the present embodiment is changed will be sequentially described. In the following description, points different from the above-described embodiment will be mainly described, and common points will be appropriately omitted.

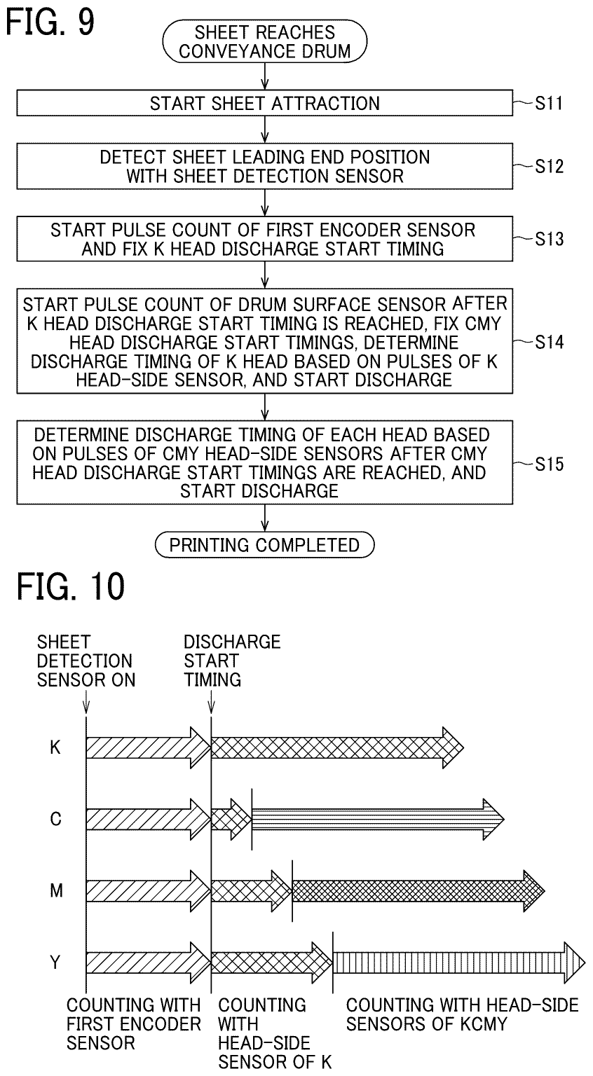

FIG. 8 is a conceptual diagram illustrating a discharge start timing and a discharge timing of each discharge unit of the liquid discharge apparatus according to a second embodiment, and FIG. 9 is a flowchart. Note that the configuration of a control section is similar to that of FIG. 7 of the above-described embodiment.

As illustrated in FIG. 8, in the present embodiment, the discharge start timing of the discharge unit 23A (discharging liquid of K; see FIG. 3), which is located most upstream among the discharge units 23, is determined only by the pulses of the first encoder sensor 52 (step S13) after the leading edge position of the sheet P is detected by the sheet detection sensor 56 (step S12 in FIG. 9). Then, after reaching the discharge timing of the discharge unit 23A, similarly to the above-described embodiment, the discharge start timings of the discharge units 23B to 23D (discharging liquid of CMY) is determined by the pulses of the drum surface sensor 55 (step S14). In other words, the discharge start timing of the discharge unit 23A is determined by the sheet detection sensor 56 and the first encoder sensor 52. The discharge start timings of the discharge units 23B to 23D are determined by the discharge start timing of the discharge unit 23A, which is a predetermined timing, and the drum surface sensor 55. In other words, the discharge start timings of the discharge units 23B to 23D are determined by the sheet detection sensor 56, the first encoder sensor 52, and the drum surface sensor 55.

After the discharge start timing of each discharge unit, the discharge timing of each discharge unit is determined based on pulses of the head-side sensors 54A to 54D provided in each discharge unit (steps S14 and S15).

As described above, according to the present embodiment, after the discharge start timing of the discharge unit 23A is determined, based on the determined timing, the discharge start timings of the other discharge units 23B to 23D can be determined by the pulses of the drum surface sensor 55. That is, the encoder scale 53 (see FIG. 3) provided on the surface of the conveyance drum 21 can be read to determine the discharge start timings of the discharge units 23B to 23D. Therefore, an error in the discharge start timings of the discharge units 23B to 23D with respect to the discharge start timing of the discharge unit 23A, that is, an error in the discharge position can be reduced. As compared with an absolute error of the position of the liquid to be discharged onto the sheet P, a relative error of the position for each color has a large influence on the quality of an image formed on the sheet P even if it is slight, and in particular, it is important to reduce the error. In the present embodiment, the error in the discharge start position between the colors can be reduced, and the quality of the image formed on the sheet P can be improved.

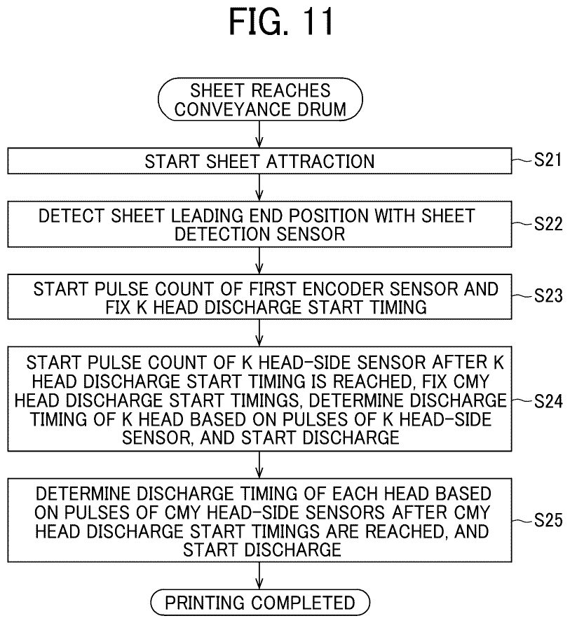

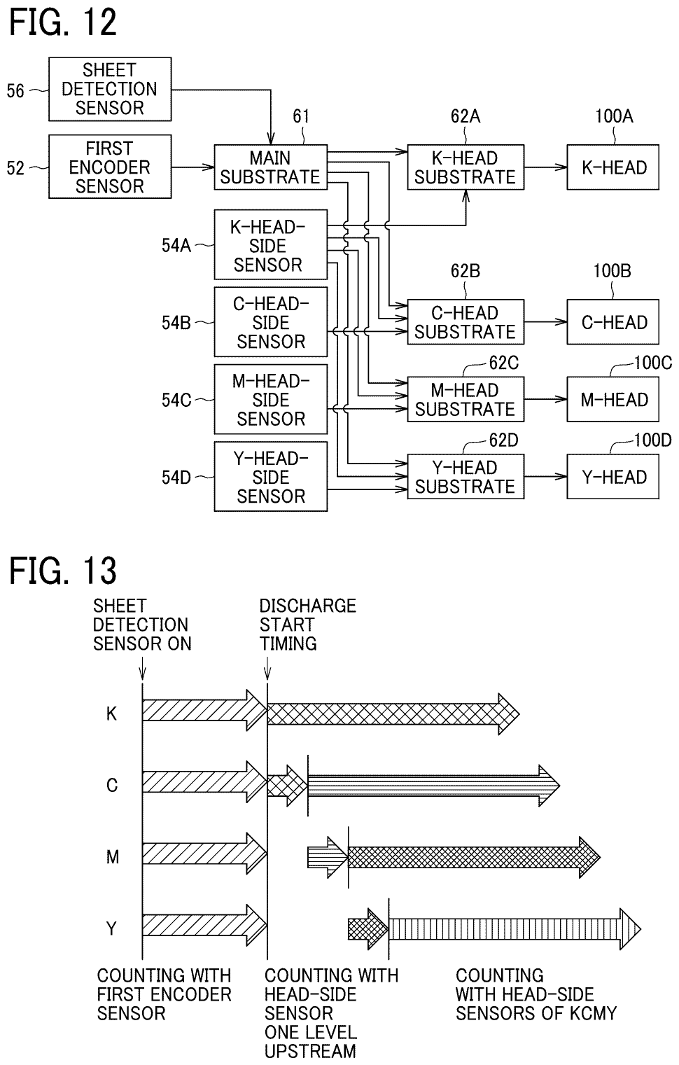

Next, for a liquid discharge apparatus according to a third embodiment of the present embodiment, FIG. 10 is a conceptual diagram for explaining a discharge start timing and a discharge timing, FIG. 11 is a flowchart, and FIG. 12 is a block diagram for explaining a configuration of a part related to the control of the discharge timing of the control section.

In the present embodiment, as illustrated in FIG. 10, when the leading end position of the sheet P is detected by the sheet detection sensor 56, the counting of the pulse of the first encoder sensor 52 is started, and the discharge start timing of the discharge unit 23A is fixed (steps S22 and S23 in FIG. 11). This point is similar to that of the second embodiment. As a difference from the second embodiment, after the discharge start timing of the discharge unit 23A is reached, the discharge start timings of the other discharge units 23B to 23D are fixed by counting pulses of the head-side sensor 54 of the discharge unit 23A (step S24). That is, the discharge start timings of the discharge units 23B to 23D are determined by the discharge start timing of the discharge unit 23A and the head-side sensor 54 of the discharge unit 23A. In other words, the discharge start timings of the discharge units 23B to 23D are determined by the sheet detection sensor 56, the first encoder sensor 52, and the head-side sensor 54 of the discharge unit 23A.

As illustrated in FIG. 12, in the present embodiment, unlike the first and second embodiments described above, the liquid discharge apparatus does not include the drum surface sensor 55 (see FIG. 3). The present embodiment is different from the above-described embodiments in that pulse information of the head-side sensor 54A provided in the discharge unit 23A is input to each of the head substrates 62A to 62D. Note that the head substrates 62A to 62D and the heads 100A to 100D correspond to the discharge units 23A to 23D, respectively.

As described above, in the present embodiment, after the discharge start timing of the discharge unit 23A is determined, with reference to the timing, the discharge start timings of the other discharge units 23B to 23D can be determined by the pulses of the head-side sensor 54A of the discharge unit 23A. Therefore, as in the second embodiment, it is possible to reduce an error in the discharge start timings of the discharge units 23B to 23D with respect to the discharge start timing of the discharge unit 23A, that is, an error in the discharge position. As a result, the quality of an image formed on the sheet P can be improved. In particular, in the present embodiment, such an effect can be obtained without providing the drum surface sensor 55 that does not correspond to each discharge unit 23.

In the second and third embodiments described above, the case where the discharge start timings of all the discharge units 23B to 23D downstream of the most upstream discharge unit 23A are determined by the pulses of the second encoder sensor from the discharge start timing of the most upstream discharge unit 23A has been described. However, the discharge start timings of all the discharge units 23B to 23D downstream are not necessarily determined, and the discharge start timings of a part of the discharge units downstream may be determined. Furthermore, it is not necessary to determine the discharge start timing of the discharge unit 23 on the downstream side with respect to the discharge start timing of the most upstream discharge unit 23A, and for example, the discharge start timing of the third and subsequent discharge units 23 may be determined by the pulses of the second encoder sensor with respect to the discharge start timing on the second upstream side. Thus, it is not necessary to apply the configuration of the present embodiment to all the discharge units.

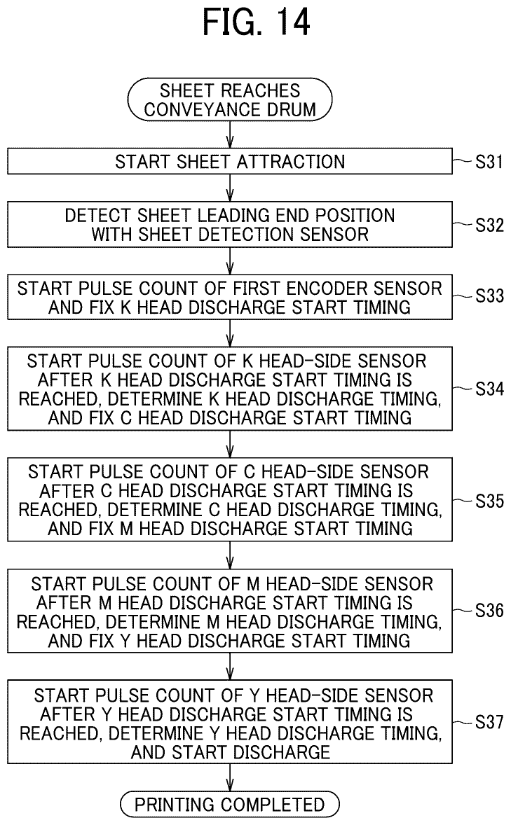

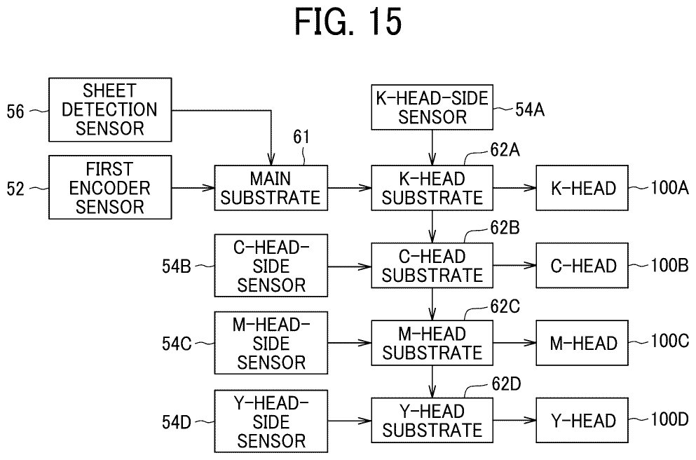

Next, with respect to a liquid discharge apparatus according to a fourth embodiment of the present embodiment, FIG. 13 is a conceptual diagram for explaining a discharge start timing and a discharge timing, FIG. 14 is a flowchart, and FIG. 15 is a block diagram for explaining a configuration of a part related to the control of the discharge timing of the control section.

As illustrated in FIG. 13, in the present embodiment, after reaching the discharge start timing of the discharge unit 23A on the most upstream side, the discharge start timing of the discharge unit 23B one level downstream of the discharge unit 23A in the conveyance direction is determined by counting pulses of the head-side sensor 54A of the discharge unit 23A (step S34 in FIG. 14). Similarly, after reaching the discharge start timing of the discharge unit 23B, the discharge start timing of the discharge unit 23C one level downstream of the discharge unit 23B in the conveyance direction is determined by counting pulses of the head-side sensor 54B of the discharge unit 23B (step S35). Then, after reaching the discharge start timing of the discharge unit 23C, the discharge start timing of the discharge unit 23D one level downstream of the discharge unit 23C in the conveyance direction is determined by counting pulses of the head-side sensor 54C of the discharge unit 23C (step S36). That is, the discharge start timing of the most upstream discharge unit 23A is determined by the sheet detection sensor 56 and the first encoder sensor 52. The discharge start timings of the discharge units 23B to 23D are determined by the discharge start timing of one of the discharge units 23 and one of the head-side sensor 54 disposed adjacent to and upstream of another of the discharge units 23 and another of the head-side sensor 54. In other words, the discharge start timings of the discharge units 23B to 23D are determined by the sheet detection sensor 56, the first encoder sensor 52, and the head-side sensor 54 of one of the discharge unit 23 disposed one level upstream of one of the discharge units 23B to 23D to which the discharge start timing is to be determined.

As described above, in the present embodiment, the discharge start timing of the discharge unit 23 is determined by the discharge start timing one level upstream of the discharge unit 23 and the pulses of the head-side sensor 54 of the discharge unit 23. Therefore, it is possible to reduce an error of each discharge start timing of the discharge units 23B to 23D with respect to the discharge start timing of the discharge unit 23 one level upstream, that is, an error of the discharge position. As a result, the quality of an image formed on the sheet P can be improved. In particular, in the present embodiment, such an effect can be obtained without providing the drum surface sensor 55 that does not correspond to each discharge unit 23.

As illustrated in FIG. 15, the present embodiment is different from the other embodiments in that information is input from the head substrate 62 of the discharge unit 23 one level upstream to the head substrate 62 on the downstream side such that information is input from the K head substrate 62A to the C head substrate 62B one level downstream, information is input from the C head substrate 62B to the M head substrate 62C, and information is input from the M head substrate 62C to the Y head substrate 62D.

In the fourth embodiment described above, except the most upstream discharge unit 23A, for all the discharge units 23 downstream of the discharge unit 23A, the discharge start timings are determined by the discharge start timing of the discharge unit 23 one level upstream and the pulses of the head-side sensor 54 of the discharge unit 23. However, the discharge start timings for only some discharge units on the downstream side may be determined. Furthermore, the discharge start timing may be determined for the discharge unit 23 second from the upstream side or downstream side thereof by the pulses of the first encoder sensor 52, and the discharge start timing may be determined for the discharge unit 23 third from the upstream side or downstream side thereof by the discharge start timing of the discharge unit 23 one level upstream and the pulses of the head-side sensor 54 of the discharge unit 23. Thus, it is not necessary to apply the configuration of the present embodiment to all the discharge units.

The second encoder sensor includes multiple head-side sensors 54 at positions respectively corresponding to the multiple discharge units 23, and the circuitry (CPU 201) determines discharge start timings of the multiple discharge units 23, based on: a discharge start timing of one of the multiple discharge units 23, disposed adjacent to and upstream of another of the multiple discharge units 23, in the conveyance direction; and a detection result of one of the multiple head-side sensors 54 disposed adjacent to and upstream of another of the multiple head-side sensors 54 in the conveyance direction.

Although the embodiments of the present embodiment have been described above, the present embodiment is not limited to the above-described embodiments, and various modifications can be made without departing from the gist of the present embodiment.

In the present embodiment, discharged liquid is not limited to a particular liquid as long as the liquid has a viscosity or surface tension to be discharged from a head. However, preferably, the viscosity of the liquid is less than or equal to 30 mPa·s under ordinary temperature and ordinary pressure or by heating or cooling. More specifically, the liquid is a solution, a suspension, an emulsion, or the like containing a solvent such as water or an organic solvent, a colorant such as a dye or a pigment, a functionalizing material such as a polymerizable compound, a resin, or a surfactant, a biocompatible material such as deoxyribonucleic acid (DNA), amino acid, protein, or calcium, an edible material such as a natural pigment, or the like, and these can be used for, for example, an inkjet ink, a surface treatment liquid, a liquid for forming a constituent element of an electronic element or a light emitting element or an electronic circuit resist pattern, a material liquid for three-dimensional modeling, or the like.

The “liquid” includes ink as well as a paint, a pretreatment liquid, a binder, and an overcoat liquid.

In the present application, a “liquid discharge apparatus” is an apparatus that includes a carriage having a liquid discharge head and drives the liquid discharge head to discharge liquid. The liquid discharge apparatus includes a device that can discharge liquid onto a recording medium to which the liquid can adhere as well as a device that discharges liquid toward gas or liquid.

The “liquid discharge apparatus” may include units to feed, convey, and eject a material on which liquid can adhere, as well as a pretreatment apparatus, and a post-processing apparatus or the like.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

Furthermore, the “liquid discharge apparatus” is not limited to an apparatus to discharge liquid to visualize meaningful images, such as letters or figures. For example, the liquid discharge apparatus may include an apparatus to form meaningless images, such as meaningless patterns, or fabricate three-dimensional images.

The above-described “material onto which liquid can adhere” represents a material on which liquid is at least temporarily adhered, a material on which liquid is adhered and fixed, or a material into which liquid is adhered to permeate. Examples of the “material on which liquid can adhere” include a recording medium, such as a sheet, recording paper, a recording sheet of paper, a film, and cloth, electronic component, such as an electronic substrate and a piezoelectric element, and a medium, such as a powder layer, an organ model, and a testing cell. The “material on which liquid can adhere” includes any material on which liquid can adhere, unless limited in particular.

Examples of the “material onto which liquid can adhere” include any materials on which liquid can adhere even temporarily, such as paper, thread, fiber, fabric, leather, metal, plastic, glass, wood, and ceramic.

Examples of the liquid discharge apparatus further include a treatment liquid applying apparatus that discharges a treatment liquid onto a sheet to apply the treatment liquid to the surface of the sheet for the purpose of reforming the surface of the sheet; and an injection granulation apparatus that injects a composition liquid, in which a raw material is dispersed in a solution, through a nozzle to granulate fine particle of the raw material.

Note that the terms “image formation”, “recording”, “printing”, “image printing”, and “fabricating” used in the present application may be used synonymously.

The functionality of the elements disclosed herein such as the CPU 201 may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The present embodiments can suppress an error in the discharge start timing by the liquid discharge head.

Aspects of the present embodiments are, for example, as follows.

### Aspect 1

According to Aspect 1, a liquid discharge apparatus includes:
a rotator that carries a recording medium on a circumferential surface and conveys the recording medium;
multiple discharge units that discharge liquid onto the recording medium;
a recording medium detector that detects the recording medium;
an encoder wheel provided on a shaft of the rotator,
a first encoder sensor that reads the encoder wheel;
an encoder scale provided on an outer circumferential surface of the rotator; and
a second encoder sensor that reads the encoder scale, in which a discharge start timing of at least one of the multiple discharge units is determined based on detection results of the recording medium detector, the first encoder sensor, and the second encoder sensor.

### Aspect 2

According to Aspect 2, in the liquid discharge apparatus of Aspect 1, based on a discharge start timing of a first liquid discharge section that is one of the multiple discharge units and a detection result of the second encoder sensor, discharge start timings of the multiple discharge units on a downstream side of the first liquid discharge section in a recording medium conveyance direction are determined.

### Aspect 3

According to Aspect 3, in the liquid discharge apparatus of Aspect 2,
the second encoder sensor includes:
a second encoder sensor that corresponds to the multiple discharge units; and
a second encoder sensor that does not correspond to the multiple discharge units, and
the discharge start timing of one or more of the multiple discharge units on a downstream side of the first liquid discharge section in the recording medium conveyance direction is determined based on a discharge start timing of the first liquid discharge section and a detection result of the second encoder sensor that does not correspond to the multiple discharge units.

### Aspect 4

According to Aspect 4, in the liquid discharge apparatus of Aspect 3, a discharge start timing of the first liquid discharge section is determined based on detection results of the recording medium detector, the first encoder sensor, and the second encoder sensor that does not correspond to the multiple discharge units.

### Aspect 5

According to Aspect 5, in the liquid discharge apparatus of Aspect 2,
the second encoder sensor includes a second encoder sensor that corresponds to the first liquid discharge section, and
a discharge start timing of one or more of the multiple discharge units on a downstream side of the first liquid discharge section in a recording medium conveyance direction is determined based on a discharge start timing of the first liquid discharge section and a detection result of the second encoder sensor that corresponds to the first liquid discharge section.

### Aspect 6

According to Aspect 6, in the liquid discharge apparatus of Aspect 2,
the second encoder sensor includes a second encoder sensor that corresponds to each of the first liquid discharge section and the multiple discharge units on a downstream side of the first liquid discharge section, and
discharge start timings of the multiple discharge units are determined based on a discharge start timing of the multiple liquid discharge section disposed one level upstream from the multiple discharge units in a recording medium conveyance direction, and a detection result of the second encoder sensor that corresponds to the multiple liquid discharge section disposed one level upstream in the recording medium conveyance direction.

### Aspect 7

According to Aspect 7, in the liquid discharge apparatus of any one of Aspect 2, Aspect 3, Aspect 5, and Aspect 6, a discharge start timing of the first liquid discharge section is determined based on detection results of the recording medium detector and the first encoder sensor.

### Aspect 8

According to Aspect 8, in the liquid discharge apparatus of any one of Aspect 2 to Aspect 7,
the second encoder sensor includes a second encoder sensor that corresponds to the multiple discharge units, and
a discharge timing after discharge start of each of the multiple discharge units is determined based on a detection result of the second encoder sensor that corresponds to each of the multiple discharge units and a discharge start timing of each of the multiple discharge units.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid discharge apparatus comprising:
a rotator rotatable around a shaft to carry a recording medium on an outer circumferential surface of the rotator to convey the recording medium in a conveyance direction;
multiple discharge units to discharge liquid onto the recording medium;
a sheet detector to detect the recording medium;
an encoder wheel on the shaft of the rotator;
a first encoder sensor to read the encoder wheel;
an encoder scale on the outer circumferential surface of the rotator;
a second encoder sensor to read the encoder scale; and
circuitry configured to determine a discharge start timing of at least one of the multiple discharge units based on detection results of the sheet detector, the first encoder sensor, and the second encoder sensor.

2. The liquid discharge apparatus according to claim 1,
wherein the multiple discharge units include a first liquid discharge section disposed most upstream of the multiple discharge units in the conveyance direction, and
the circuitry determines a discharge start timing of one or more of the multiple discharge units disposed downstream of the first liquid discharge section in the conveyance direction after a predetermined timing based on a detection result of the second encoder sensor.

3. The liquid discharge apparatus according to claim 2,
wherein the second encoder sensor includes:
multiple head-side sensors at positions respectively corresponding to the multiple discharge units; and
a drum surface sensor at a position not correspond to the multiple discharge units, and
the circuitry determines the discharge start timing of one or more of the multiple discharge units disposed downstream of the first liquid discharge section in the conveyance direction based on a detection result of the drum surface sensor.

4. The liquid discharge apparatus according to claim 3,
wherein the circuitry determines a discharge start timing of the first liquid discharge section based on detection results of the sheet detector, the first encoder sensor, and the drum surface sensor.

5. The liquid discharge apparatus according to claim 3,
wherein the drum surface sensor is disposed upstream of the multiple head-side sensors and downstream of the sheet detector in the conveyance direction.

6. The liquid discharge apparatus according to claim 2,
wherein the second encoder sensor includes multiple head-side sensors at positions respectively corresponding to the multiple discharge units,
the multiple head-side sensors include a first head-side sensor at a position corresponding to the first liquid discharge section, and
the circuitry determines the discharge start timing of one or more of the multiple discharge units disposed downstream of the first liquid discharge section in the conveyance direction based on a discharge start timing of the first liquid discharge section and a detection result of the first head-side sensor.

7. The liquid discharge apparatus according to claim 2,
wherein the second encoder sensor includes multiple head-side sensors at positions respectively corresponding to the multiple discharge units, and
the circuitry determines discharge start timings of the multiple discharge units based on:
a discharge start timing of one of the multiple discharge units disposed adjacent to and upstream of another of the multiple discharge units in the conveyance direction; and
a detection result of one of the multiple head-side sensors disposed adjacent to and upstream of another of the multiple head-side sensors in the conveyance direction.

8. The liquid discharge apparatus according to claim 2,
wherein the circuitry determines a discharge start timing of the first liquid discharge section based on detection results of the sheet detector and the first encoder sensor.

9. The liquid discharge apparatus according to claim 2,
wherein the second encoder sensor includes multiple head-side sensors at positions respectively corresponding to the multiple discharge units, and
the circuitry determines a discharge timing after discharge start of each of the multiple discharge units based on detection results of the multiple head-side sensors and a discharge start timing of each of the multiple discharge units.
